(19) United States
(12) Patent Application Publication
(10) Pub. No.: US 2025/0207716 A1
(43) Pub. Date: Jun. 26, 2025

(54) Thermal Transfer Line Assemblies, Methods for Manufacturing Thermal Transfer Line Assemblies, and Thermal Transfer Methods

(71) Applicant: Montana Instruments Corporation, Bozeman, MT (US)

(72) Inventors: Josh Doherty, Bozeman, MT (US); William Baker, Bozeman, MT (US); Joseph Evers, Bozeman, MT (US); Ben Hardesty, Belgrade, MT (US); Jamesen Motley, Bozeman, MT (US); Anjan Reijnders, Bozeman, MT (US); Caleb Schreibeis, Bozeman, MT (US)

(73) Assignee: Montana Instruments Corporation, Bozeman, MT (US)

(21) Appl. No.: 19/079,838

(22) Filed: Mar. 14, 2025

Related U.S. Application Data
(63) Continuation of application No. 16/586,599, filed on Sep. 27, 2019, now Pat. No. 12,253,205.
(60) Provisional application No. 62/738,759, filed on Sep. 28, 2018.

(51) Int. Cl. F16L 59/065; F16L 59/08; F16L 59/14

(52) U.S. Cl. CPC F16L 59/065; F16L 59/08; F16L 59/141

(57) ABSTRACT

Thermal transfer line assemblies are provided. Methods for manufacturing a thermal transfer line assembly are also provided. Methods for transferring thermal energy are also provided.

### CROSS REFERENCE TO RELATED APPLICATION

This application is a continuation of U.S. patent application Ser. No. 16/586,599 filed Sep. 27, 2019, entitled “Thermal Transfer Line Assemblies, Methods for Manufacturing Thermal Transfer Line Assemblies, and Thermal Transfer Methods”, which claims priority to and the benefit of U.S. Provisional Patent Application Ser. No. 62/738,759 filed Sep. 28, 2018, entitled “Thermal Transfer Line Assemblies and Thermal Transfer Methods”, the entirety of each of which is incorporated by reference herein.

### TECHNICAL FIELD

The present disclosure provides assemblies and methods that can be used to transfer thermal energy between a mass and a thermal source or sink. Example implementations of the present disclosure provide thermal transfer line assemblies and/or thermal transfer methods.

### BACKGROUND

Thermal transfer is used to transfer thermal energy between a mass and a thermal source or sink. Using a thermal transfer line assembly, the mass can be heated or cooled. Particular technologies require providing low temperatures to a specific mass or multiple masses. To provide these low temperatures, a cold source, or thermal sink is provided that can be anything from a cooling bath to a cryocooler. Heat from the mass or masses is transferred from the mass or masses to the cold source or thermal sink via a thermal transfer line, thus lowering the temperature of the mass or masses. Isolating the transfer line from environmental temperatures can reduce the thermal load on the cold source and increase the efficiency of heat removal from the mass or masses. The present disclosure provides thermal transfer line assemblies and methods that can, in accordance with example implementations, reduce the thermal load on the cold source and/or increase efficiency of heat removal.

### SUMMARY

Thermal transfer line assemblies are provided that can include: a vacuum housing; a suspension support housing within the vacuum housing; a thermal conduit within the suspension support housing; in at least one cross section, a continuous outer void between the vacuum housing and the suspension support housing, wherein the vacuum housing is disconnected from the suspension support housing in the one cross section; and in the one cross section, an inner void between the suspension support housing and the thermal conduit.

Methods for manufacturing a thermal transfer line assembly are also provided. The methods can include: providing a thermal conduit; providing a suspension support housing about the thermal conduit to define an inner void between the suspension support housing and the thermal conduit; and providing a vacuum housing about the suspension support housing to define an outer void between the vacuum housing and the suspension support housing.

Methods for transferring thermal energy are also provided. The methods can include transferring thermal energy via a thermal conduit within an inner void of a suspension support housing.

### BRIEF DESCRIPTION OF DRAWINGS

Embodiments of the disclosure are described below with reference to the following accompanying drawings.

FIG. 1 is depiction of a thermal source or sink in operative configuration with a mass via a thermal transfer line according to an embodiment of the disclosure.

FIGS. 2A and 2B are both an elevational view and a cross sectional view of a thermal transfer line assembly according to an embodiment of the disclosure.

FIGS. 3A and 3B are both an elevational view and a cross sectional view of a thermal transfer line assembly according to an embodiment of the disclosure.

FIG. 4 is a cross sectional view of a thermal transfer line assembly according to an embodiment of the disclosure.

FIG. 5 is a cross sectional view of a thermal transfer line assembly according to an embodiment of the disclosure.

FIG. 6 is a cross sectional view of a thermal transfer line assembly according to an embodiment of the disclosure.

FIG. 7 is an elevational view of a thermal transfer line assembly according to an embodiment of the disclosure.

### DESCRIPTION

This disclosure is submitted in furtherance of the constitutional purposes of the U.S. Patent Laws “to promote the progress of science and useful arts” (Article 1, Section 8).

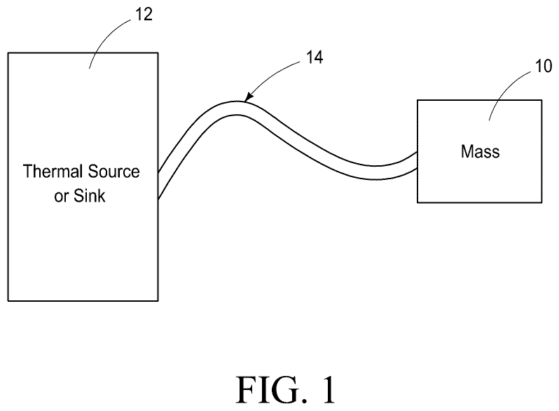

The assemblies and methods of the present disclosure will be described with reference to FIGS. 1-7. Referring first to FIG. 1, a block diagram of a mass 10 of interest in thermal communication with a thermal source or sink 12 via a thermal transfer line assembly 14 is depicted. Thermal transfer line assembly 14 of the present disclosure can provide significantly reduced heat load or loss and therefore better thermal transfer efficiency between thermal source or sink 12 and mass 10 of interest. Thermal transfer line assemblies 14 can also provide significantly reduced mechanical energy (vibration) transfer from thermal source or sink 12 to mass 10 of interest.

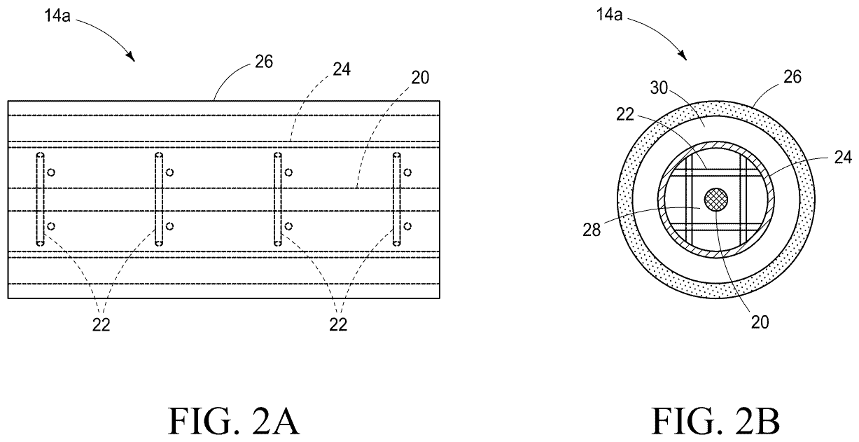

Referring to FIGS. 2A and 2B, an embodiment of a thermal transfer line assembly 14a is depicted that can include a thermal conduit 20, conduit suspension or suspension system 22, suspension support housing 24, and vacuum housing 26. Thermal conduit 20 can provide for the transfer of the thermal energy to/from thermal source or sink 12 to the mass 10 of interest. Thermal conduit 20 can conduct thermal energy via solid conduction, via copper bar, copper wire, or copper braid for example. Thermal conduit 20 may also be configured as a tube, pipe, or hose, such as a stainless steel tube, that can transfer a fluid, such as a cryogenic fluid, from thermal source or sink 12 to mass 10 of interest.

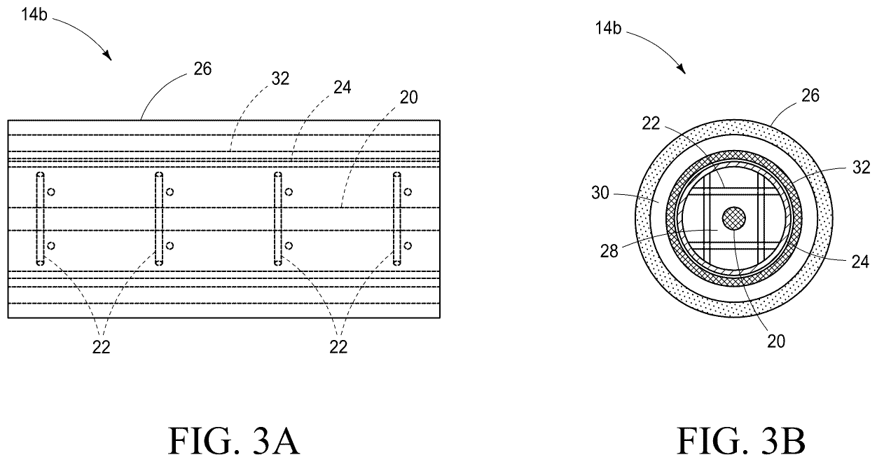

Suspension system 22 can be configured to suspend thermal conduit 20 within a space or inner void 28 within the surrounding structure which can include a suspension support housing 24, shielded or unshielded. Suspension system 22 can limit physical contact, particularly thermal contact, between thermal conduit 20 and any surrounding structure, thus minimizing conductive heat transfer to/from the thermal conduit at its surrounding environment. In accordance example implementations, in at least one cross section (e.g., FIGS. 2B and 3B), there can be a continuous outer void 30 between vacuum housing 26 and suspension support housing 24. As an example, this outer void can be continuous disconnecting suspension support housing 24 from vacuum housing 26. In accordance with at least some of these implementations, thermal conduit 20 can float inside suspension support housing 24 and/or in accordance with other implementations within suspension system 22. In accordance with at least some of these embodiments, mechanical contact between thermal conduit 20 and any surrounding structure is minimized and/or eliminated, thus minimizing the transfer of mechanical energy to thermal conduit 20 from its surrounding environment. Suspension system 22 can be constructed of thread (such as nylon floss) or wire that is attached at discrete locations along the length of suspension support housing 24 in a manner that creates an inner cage around thermal conduit 20. Suspension system 22 may also include spacers between thermal conduit 20 and suspension support housing 24 that are chosen of specific geometry and material to minimize heat transfer and transfer of mechanical energy to/from thermal conduit 20. Suspension support housing 24 may limit the motion of thermal conduit 20 within transfer line assembly 14. Suspension support housing 24 can be any type of hose or tube, made of Teflon for example, that is not brittle at low temperatures for cryogenic applications.

Vacuum housing 26 can provide an evacuated space in which thermal conduit 20, suspension system 22, and/or suspension support housing 24 can be located, as to minimize convective or conductive heat transfer to/from thermal conduit 20. Vacuum housing 26 can be any type of hose, tube, or structure that can support an interior vacuum pressure. Vacuum housing 26 can be configured as bellows, and in particular embodiments, edge welded bellows. The ability to be bent, flexed, or twisted is desirable for transfer line assembly 14, and materials of construction may be chosen accordingly.

Referring next to FIGS. 3A and 3B, a thermal transfer line assembly 14b can include a radiation shield member 32. In one embodiment, radiation shield member 32 can extend the length of thermal transfer line assembly 14b and can shield thermal conduit 20 from radiative heat transfer to/from thermal conduit 20 to the surroundings. Radiation shield member 32 can be flexible, for example, and can be constructed of one or more multiple layers of copper braid that defines a space for suspension support housing 24 and suspension system 22. Radiation shield member 32 may also be rigid or semi-rigid. Radiation shield member 32 can also be a rigid copper tube, for example, or radiation shield member 32 may be semi-rigid and configured of sections of rigid copper tube separated by sections of copper bellows soldered to the rigid section ends.

In one embodiment, thermal transfer line assembly 14 may also comprise multi-layer insulation (MLI) or super insulation that can minimize radiative and conductive heat transfer to/from the surrounding environment to thermal conduit 20 and/or or radiation shield member 32. This insulation can be provided to within outer void 30, for example.

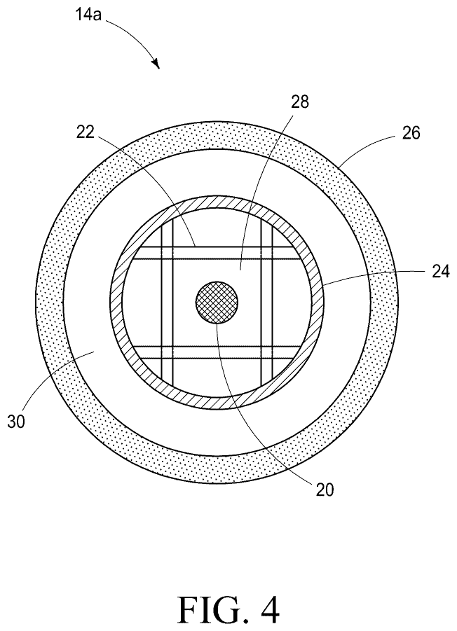

Referring next to FIG. 4, suspension system 22 can be constructed of a cage of floss or thread. In this embodiment, suspension support housing 24 can have small holes positioned around the circumference that the floss or thread can be threaded through and then tied, creating a grid of floss/thread about thermal conduit 20. These holes and suspension system 22 can be positioned at multiple discrete locations along the length of the suspension support.

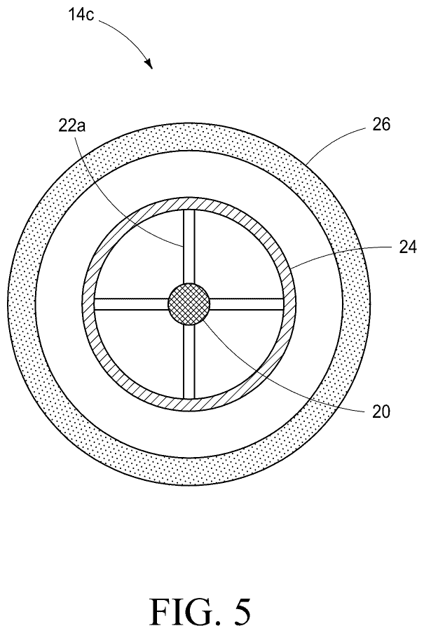

Referring next to FIG. 5, an assembly 14c is shown with a suspension system 22a constructed of floss or thread attached to thermal conduit 20 at multiple locations and configured to suspend thermal conduit 20 about the center of suspension support housing 24. Here, suspension support housing 24 can have small holes positioned around the circumference that the floss or thread can be threaded through and tied. These holes and system 22a can be positioned at multiple discrete locations along the length of suspension support housing 24. In accordance with this implementation, less suspension structure can provide additional thermal isolation. In accordance with this implementation, system 22a can connect housing 24 and conduit 20, but infrequently, thus still providing substantial thermal isolation.

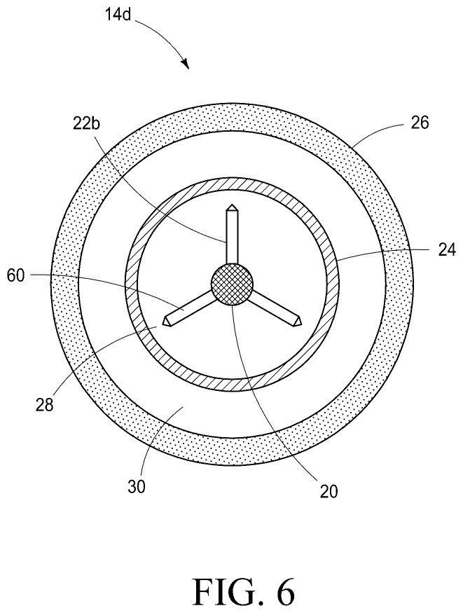

With reference to FIG. 6, an assembly 14d having a suspension system 22b is shown that can be constructed of small length needles 60 attached to and arranged around a circumference of thermal conduit 20, as spokes from a hub, for example. Here, two of the three needles 60 may be in thermal contact with the suspension support housing 24 at one time, while at others, and in accordance with the shown cross section, both conduit 20 and system 22b float within void 28 defined by housing 24. Needles 60 can be positioned at multiple discrete locations along the length of suspension support housing 24. Needles 60 can have beveled, narrow, or even sharp tips that provide small point contacts between thermal conduit 20 and suspension support housing 24.

In accordance with at least one implementation, thermal transfer line assemblies 14 can be flexible, allowing the mass 10 of interest to be moved in position relative to the thermal sink or source 12. Accordingly, suspension systems 22, suspension support housing 24, thermal conduit 20, vacuum housing 26, and/or possibly radiation shield 32 may be individually flexible. To minimize the transfer of mechanical energy to mass 10 of interest, in one implementation, suspension systems 22, suspension support housing 24, thermal conduit 20, vacuum housing 26, and/or possibly radiation shield 32 are mechanically de-coupled (loosely connected). In accordance with another implementation, thermal transfer line assembly 14 may be utilized to maintain multiple masses of interest at potentially different temperatures. Accordingly, thermal transfer line assembly 14 may include more than one thermal conduit 20, suspension system 22, suspension support housing 24, and/or radiation shield 32.

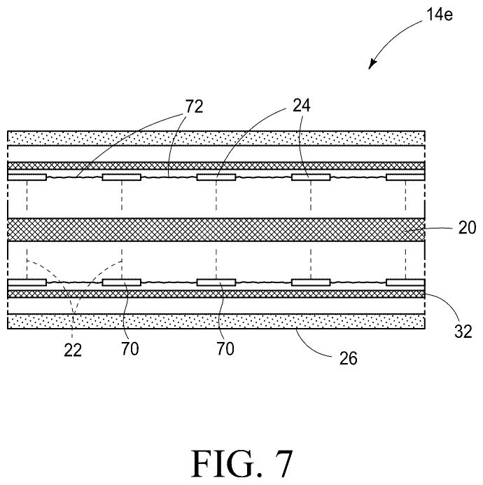

Referring to FIG. 7, in accordance with another implementation, assembly 14e is shown that includes suspension support housing 24 that is defined by a plurality of sections 70 along the length of thermal transfer line assembly 14e that are loosely connected, thermally and mechanically, as to minimize the transfer of thermal and/or mechanical energy from one section to the next. Suspension support housing 24, defined by multiple sections 70, can be constructed of metal, such as aluminum, or plastic sections that are loosely connected with members 72. Sections 70 can be less elastic than members 72. For example, members 72 can be constructed of Nylon or Kevlar thread.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A thermal transfer conduit assembly comprising:
a vacuum housing;
a suspension support housing within the vacuum housing;
in at least one cross section, an outer void between the suspension support housing and the vacuum housing;
a thermal conduit within the suspension support housing;
in the at least one cross section, an inner void between the suspension support housing and the thermal conduit; and
a plurality of members extending substantially normally from the thermal conduit to provide a suspension system for the thermal conduit in relation to the suspension support housing.

2. The thermal transfer conduit assembly of claim 1 wherein one or more of the vacuum housing, the suspension support housing, and/or the thermal conduit may individually or together be flexible.

3. The thermal transfer conduit assembly of claim 1 wherein the plurality of members comprises at least three members.

4. The thermal transfer conduit assembly of claim 3 wherein the at least three members are arranged equidistant about the thermal conduit.

5. The thermal transfer conduit assembly of claim 1 wherein each of the members comprise one end fixed to the thermal conduit.

6. The thermal transfer conduit assembly of claim 5 wherein each of the members comprises an opposing free end.

7. The thermal transfer conduit assembly of claim 6 wherein the free end is conical.

8. The thermal transfer conduit assembly of claim 6 wherein in some configurations the free end will engage the suspension support housing.

9. The thermal transfer conduit assembly of claim 1 wherein each of the members comprises insulative material.

10. The thermal transfer conduit assembly of claim 1 further comprising sets of the plurality of members located along a plurality of positions along a length of the thermal conduit.

11. A thermal transfer conduit assembly comprising:
a vacuum housing;
a suspension support system within the vacuum housing, the suspension support system comprising a plurality of sections operably linked by flexible members, each of the sections comprising a suspension support housing and suspension member; and
a thermal conduit within the suspension support system.

12. The thermal transfer conduit assembly of claim 11 wherein in at least one cross section, the suspension member extends normally from the suspension support housing.

13. The thermal transfer conduit assembly of claim 11 wherein each of the sections are spaced equidistant along the length of the conduit assembly.

14. The thermal transfer conduit assembly of claim 11 further comprising a radiation shield between the suspension support assembly and the vacuum housing.

15. The thermal transfer conduit assembly of claim 11 wherein the sections comprise insulative material.

16. The thermal transfer conduit assembly of claim 11 wherein the sections comprise plastic materials.

17. The thermal transfer conduit assembly of claim 11 wherein the suspension members comprise nylon and/or Kevlar thread.
